(19) United States
(12) Patent Application Publication
(10) Pub. No.: US 2019/0391372 A1
(43) Pub. Date: Dec. 26, 2019

(54) METROLOGICAL OPTICAL IMAGING DEVICE AND SYSTEM FOR DETERMINING A POSITION OF A MOVABLE OBJECT IN SPACE

(71) Applicant: Carl Zeiss Industrielle Messtechnik GmbH, Oberkochen (DE)

(72) Inventors: Nils Haverkamp, Aalen (DE); Johannes Winterot, Jena (DE)

(21) Appl. No.: 16/451,583

(22) Filed: Jun. 25, 2019

(30) Foreign Application Priority Data
Jun. 25, 2018 (DE) 10 2018 115 197.7

(51) Int. Cl. G02B 13/24; G02B 9/62; G02B 9/60; G02B 9/16

(52) U.S. Cl. CPC G02B 13/24; G02B 9/16; G02B 9/60; G02B 9/62

(57) ABSTRACT

A metrological optical imaging device for imaging a movable object located in an object space onto an image space to determine a position of the object in the object space includes at least one lens group including an image-side lens group and a stop defining an entrance pupil for beams emanating from the movable object. The entrance pupil has a same pose for at least two of the beams having different field angles. The at least one lens group and the stop are arranged in an object-side focus of the image-side lens group, and the metrological optical imaging device is arranged between the object space and the image space.

### CROSS REFERENCE TO RELATED APPLICATIONS

This application claims priority to German patent application DE 10 2018 115 197.7, filed Jun. 25, 2018, the entire content of which is incorporated herein by reference.

### TECHNICAL FIELD

The disclosure relates to a metrological optical imaging device for imaging a movable object, located in an object space, onto an image space to determine a position of the object in the object space, a metrological system for determining the position of the movable object in the object space, and methods for determining the position of the movable object in the object space with one or more metrological optical imaging devices or pinhole cameras.

### BACKGROUND

Processing and/or measuring machines that use tools for processing or measuring workpieces in interaction with one another are used in modern industrial production. In so doing, the tools and the workpieces must be matched to one another in respect of their positions or poses, i.e., their x-, y-, and z-coordinates and/or their orientations, in a reference system to avoid or at least correct process errors and unacceptable quality defects of the end product during early phases of production.

Therefore, it is essential to determine with sufficient accuracy the position, the orientation and/or the derivatives with respect to time and/or space thereof of the processing or measuring tools relative to one another, to the workpiece or to an external coordinate system.

Sensors whose signal represents the position in units of a calibrated variable are used for generating such position information items. This calibrated variable is transferred to the machine within the scope of feedback or a calibration with standards that are fed back. Sensors that measure both in absolute and relative or incremental fashion are considered to this end, the required position information item being ascertained either directly or by differentiation or integration by said sensors.

Despite the significant outlay in the construction of the machines and sensors, it is a great challenge to meet the high requirement in respect of the accuracy of the position determination in a satisfactory manner. This can be traced back, inter alia, to factors such as loads, speeds, accelerations, workpiece expansions, environmental conditions (so-called “external factors”) influencing the movements of the machines and causing path deviations.

As a rule, the position measuring method therefore requires a complicated correction for high-accuracy applications in order to sufficiently compensate measurement errors linked to the path deviations. Nevertheless, there are limits to such correction measures, particularly because it is difficult or impossible to completely describe the path deviations by mathematical models. Therefore, a parameter window for the so-called “intended use” is regularly specified for the machines by virtue of specifying the external factors for which the respective machine achieves its accuracy specified by the manufacturer.

One reasons for this problem is that the machine position is determined in relation to an internal reference system (so-called “internal material measure”). This leads to changes on the machine due to external factors which lead to a change in the reference with respect to the internal reference system. In order to decouple the accuracy of the position determination for machines from the external factors, research was conducted in respect of solutions that use an external reference system, in a manner analogous to radio and satellite navigation from marine and aeronautical engineering. However, to date, these solutions have not reached cost benefit ratios which facilitate an expedient industrial application from a commercial point of view. The main reason for this lies in the high technical complexity of the employed technology, for example femtosecond lasers, which are required to obtain a high resolution accuracy of 1 micrometer and a high measuring rate of 1 kHz.

The use of the constantly growing possibilities of digital optics provides a comparatively simple solution for capturing the position of measuring and processing machines. In the process, an image-processing sensor system is used, the latter embodying an external reference system, in respect of which the position of the machine can be determined based on the principle of triangulation. A plurality of cameras are positioned, for example, around the machine, the tool or the workpiece, said cameras capturing the position of markers attached to the machine, to the tool or to the workpiece. This measuring method is referred to as “optical tracking”, in which the respective positions of the machine, of the tool or of the workpiece relative to one another can be determined from the positions of the markers relative to one another.

In this way, it is possible to dispense with reference systems embedded in the machine (e.g., linear scales, rotary angle encoders, speedometers, etc.). Since the digital-optical determination of the position is implemented with respect to an external reference system, the external factors or changes on the machine no longer affect the measurement result. As a result, the complicated correction measures, required otherwise, for taking account of the interaction between the machine and the surroundings, and for taking account of the measurement scenario, are superfluous.

Optical devices have been described in the related art which have been developed specifically for optical tracking. However, such optical devices cannot be used for highly accurate measuring or processing machines, in which a resolution accuracy of 1 micrometer is required. In particular, the known optical devices have imaging aberrations that are not sufficiently correctable; these imaging aberrations hinder the advance into the desired accuracy range. Those distortions which are dependent on the distance between the object to be imaged (e.g., marker) and the objective lens have a particularly impairing effect on the measurement accuracy. This problem becomes more acute when positions are determined using a three-dimensional imaging method.

U.S. Pat. Nos. 3,519,325 A and 4,908,705 A describe optical systems used in a reconnaissance aircraft for localizing objects on the ground during the flight. These optical systems are not suitable for use in metrology since they are designed for imaging an object with an infinite object distance, while object distances in metrology lie in the range from a few meters to ten meters.

### SUMMARY

It is therefore an object of the present disclosure to provide an optical imaging device for industrial metrology of the type described above, in which the dependence of the distortion on the distance between the object to be imaged and the objective lens is eliminated.

The object is achieved by a metrological optical imaging device, a method and a metrological system for determining a position of a movable object in an object space, as disclosed herein.

The metrological optical imaging device for imaging a movable object located in an object space onto an image space to determine the position of the object in the object space, includes: at least one lens group including an image-side lens group, a stop defining an entrance pupil for beams emanating from the movable object, the entrance pupil having a same pose for at least two of the beams having different field angles, the at least one lens group and the stop being arranged in an object-side focus of the image-side lens group, and the metrological optical imaging device being arranged between the object space and the image space.

According to an aspect of the disclosure, the optical imaging device is an objective lens, typically a camera objective lens. The movable object can be one or more markers, which is/are attached to a measuring and/or processing machine. The movable object can be a part of the machine, for example a rough surface of the machine. Alternatively, the movable object can be a robotic arm (for example for mirror production), the 6-dimensional (6D) position of which must be accurately known and controlled. Other examples relate to the 6D position control of movable mirrors, for example in a projection exposure apparatus for producing a precise image of a reticle structure on the semiconductor substrate to be exposed.

The at least one lens group includes at least one lens, for example a convex or concave lens. Moreover, a plurality of lens groups may be provided, which are arranged at a distance from one another along the optical axis. Typically, the at least one lens group has positive refractive power.

Typically, the stop is a pinhole and can be formed by an etched metal film, for example. The at least one lens group and the stop are positioned and formed in such a way that the entrance pupil for beams emanating from the movable object has a constant pose, independently of the respective field angles at which the beams enter. Here, the pose of the entrance pupil means the spatial coordinates and/or orientation thereof. On account of the constant pose, the field angle at which the corresponding object point lies can be uniquely deduced from the position of an image point in the image space.

The optical imaging device may include a first, optionally virtually afocal or scattering lens group. Additionally, the optical imaging device may include a second, optionally converging lens group with positive refractive power. An image sensor, on which the movable object can be imaged by the optical imaging device, may be contained in the optical imaging device or may be provided separately thereof.

The afocal lens group or scattering front group is arranged without trimming between the movable object and the stop. The goal of this measure is to design the vignetting to be as low as possible.

“Without trimming” should be understood to mean that only the stop delimits the beam for all image points to be evaluated. The beam cross section perpendicular to the beam changes into an ellipse. A common method is that of additionally using lens holders for beam shaping purposes for off-axis image points. The beam cross section becomes a digon or something more complicated.

If the front group is dispensed with, the objective lens is converted into a front-stop objective lens and has, a priori, the described properties. The converging lens group or back group with positive refractive power is arranged without trimming between the stop and the image plane. Typically, the stop is positioned in the object-side or front focus of the image-side lens group (back group). The image plane lies downstream of the image-side or back focus and is conjugate to an object plane from the interior of the measurement volume. The overall system is corrected in respect of asymmetric aberrations. On account of the constant pose of the entrance pupil and on account of the asymmetric-aberration-free imaging, the field angle at which the corresponding object point lies can be uniquely deduced from the position of an image point in the image space.

According to an aspect of the disclosure, the distortion aberrations, in particular the distortions depending on the distance between the movable object (e.g., the marker) and the objective lens (i.e., distance-dependent distortions), and/or perspective distortions can be effectively reduced or avoided. This means that the optical imaging device according to an aspect of the disclosure with the digital distortion correction at least comes closer to a pinhole camera or a camera obscura in respect of the achieved distortion freedom and thus realizes “pinhole optics”. On account of the independence with respect to distance of the distortion, it is possible to calibrate the optical imaging device with significantly less outlay than conventional optical devices in a calibration setup.

A linear relationship between the sensor coordinates and the position to be determined is desired for reasons of speed. As a rule, distortions of the optical device have a nonlinear characteristic. Realizing a distortion-corrected optical device requires much outlay. By contrast, a digital distortion correction is quick and economical if distortions are independent of distance and the optical device can easily be calibrated. This is the case in exemplary embodiments of the present disclosure, having an advantageous effect on a reliable determination of the position.

On account of the reduced or avoided distortion aberrations, the determination of the position of the machines in the image space can be significantly improved. Consequently, the position of the imaged object in the object space can be deduced with correspondingly increased accuracy from the position of the image in the image space of the optical imaging device. The navigation of movable objects on the basis of the triangulation can therefore be improved.

Compared to the known systems of 3D metrology, which do not realize a high degree of accuracy or only realize a high degree of accuracy by using additional information items about the imaged object and a calibration of the imaging properties that is very complicated in part, the optical imaging device according to an aspect of the present disclosure is significantly simplified and can therefore also be produced in a more cost-effective manner. Moreover, the computational outlay can be significantly reduced by the optical imaging device according to an aspect of the disclosure. The known systems for determining positions are approximating or iterative measuring methods, leading to significant computational outlays and making such systems less suitable for high-speed measuring systems.

A further advantage of the optical imaging device according to an aspect of the disclosure lies in overcoming the problem of imaging aberrations only being partly correctable in the known systems; this can be traced back to the fact that a complete correspondence of system and environmental parameters between the use scenario and the calibration scenario cannot be guaranteed.

While correction measures are necessary in the known systems for the purposes of subsequently rectifying measurement errors in the determination of positions on account of imaging aberrations, a completely different solution is pursued according to an aspect of the disclosure, specifically that of contriving a system in which the imaging aberrations (in particular distance-dependent and/or perspective distortions) are reduced or avoided from the outset by way of a simple calibration. Consequently, the underlying problem of the measuring inaccuracy when determining positions is actively tackled at the root instead of being passively corrected.

According to another aspect of the disclosure, a position of an object in space is understood to mean a position according to N degrees of freedom of movement, where N may be 2, 3, 4, 5 or 6. By way of example, a 6D position is a position of the object in space according to 3 degrees of freedom of translation and 3 degrees of freedom of rotation. Consequently, the term position also includes an orientation of the object in space.

According to yet another aspect of the disclosure, the stop is arranged within the at least one lens group.

A central stop is realized by a stop arranged within the lens group. Together, the at least one lens group and the central stop define an entrance pupil, the pose of which remains unchanged for entrance beams with different field angles. The optionally scattering front member (specifically, the object-side lens group) reduces the field angle between the object space and the stop space. As a result, the beam cross section of the entrance beam is increased in relation to a system with a front stop and the vignetting is reduced. At the location of the stop, the beam cross section of an off-axis point is an ellipse. The semi-major axis corresponds to the stop diameter, with the semi-minor axis equaling the product of the stop diameter and the cosine of the beam angle or angle of incidence. The semi-minor axis, and hence the beam cross section, increases with a smaller beam angle. The resultant image of the movable object has a higher gradient from edges away from the optical axis and is more precisely detectable with less vignetting. Different focal lengths of the objective lens are provided for different measurement volumes in the case of the given sensor size. The object field angle reduces with increasing focal length and the quotient of field angle and angle of the beam at the location of the stop approaches 1. The front member can be dispensed with below a field angle of 25°.

The stop is arranged in an object-side focus of the image-side lens group and typically arranged between an object-side lens group and the image-side lens group of the at least one lens group in the object-side (front) focus of the image-side lens group. The stop serves as a front stop for the second lens group. This measure facilitates a high lateral detection accuracy of off-axis points in the case of unsharp imaging of objects outside of the object plane conjugate to the image sensor.

The stop central rays (focus rays) are imaged at infinity. Typically, the system is telecentric on the image side. Thermally induced changes in the distance between optical device and sensor do not lead to an edge displacement. The object-side lens group and the image-side lens group each include at least one lens, for example a convex or a concave lens. Alternatively, at least one of the two lens groups may include both a convex and a concave lens. This measure increases the design variety of the optical imaging device or of the objective lens.

According to a further aspect of the disclosure, the image-side lens group has a positive refractive power.

Consequently, the second lens group is a converging lens group with at least one convex lens. The optical imaging device can be produced in a cost-effective manner on account of the simple availability of convex lenses.

According to another aspect of the disclosure, the focal length of the image-side lens group lies in a range from 15 mm to 200 mm.

This measure facilitates a plurality of choices for the image-side lens group such that the very different requirements in respect of the accuracy of the determination of positions can be satisfied for diverse application scenarios.

According to a further aspect of the disclosure, the object-side lens group and the image-side lens group together define a focal length in a range from 5 mm to 200 mm.

For a given measurement volume and sensor size, the measurement accuracy can be optimally matched to the requirements of the determination of positions by way of a suitable choice of the focal length.

The object-side lens group is afocal according to a further aspect of the disclosure.

The overall focal length is approximately determined from the focal length of the back member multiplied by the telescope magnification of the front member. The telescope magnification defines the vignetting for object field angles defined from the sensor size and focal length. In order to achieve a good overall performance, the focal length of the back member should be designed maximally and the telescope magnification should be designed for the vignetting that is still acceptable. A Galilean telescope is preferred for the afocal front member for reasons of stability. According to a further preferred configuration, the object-side lens group has a refractive power that, in terms of absolute value, is less than 0.05. As a result of this, the object-side lens group is completely or at least virtually afocal.

According to an aspect of the disclosure, the focal length of the image-side lens group is greater than or equal to the focal length of the overall system.

This is advantageous for reducing the vignetting. Then, the diameter of the stop is greater than the diameter of the entrance pupil. The field angle of off-axis object points reduces in the stop space. The meridional beam extent increases. Consequently, the vignetting is less than in a system with a front stop or a converging effect of the front member.

According to a further aspect of the disclosure, the ratio between the focal length of the at least one lens group and the focal length of the image-side lens group lies in a range from 0.3 to 1.

This means that the focal length of the at least one lens group is at least 0.3-times the focal length of the image-side lens group and no longer than the focal length of the image-side lens group.

According to yet another aspect of the disclosure, the object-side lens group has a telescope magnification factor that, in terms of absolute value, is less than 1.

This measure reduces the vignetting. Further, the telescope magnification factor is in a range from 0.3 to 1 in terms of absolute value.

According to an aspect of the disclosure, the object-side lens group has the characteristics of a Kepler and/or Galilean telescope.

Kepler telescopes are constructed from two groups of positive refractive power. The image-side focus of the object-side lens group coincides with the object-side focus of the image-side lens group. Consequently, Kepler telescopes have a long installation length and tend to be rather unstable within the scope of the measuring problem to be solved. The “special” Galilean telescopes, which are referred to here, are constructed from a lens group of negative refractive power arranged on the object side and a lens group of positive refractive power arranged on the image side, with the foci likewise coinciding. Advantageously, the Galilean telescope allows a more compact construction and is typical as a design for the object-side lens group.

According to a further aspect of the disclosure, the at least one lens group includes a first lens and a second lens, which is arranged on the image side with respect to the first lens, wherein the first and/or the second lens has an object-side lens face and an image-side lens face, wherein the object-side lens face has a concentric embodiment in respect of a principal beam path and the image-side lens face has an aplanatic embodiment in respect of the principal beam path.

This can significantly reduce the aberrations in the principal beam path of arbitrary field angles. Virtually all principal beam paths with field angles in the range from 0° to 90° extend through the center of the stop, which is typically arranged on the image side of the second lens.

According to another aspect of the disclosure, the stop has a diameter that satisfies the condition:

0.03·f_{LG2}<D<0.10·f_{LG2}

where D represents the diameter of the stop and f_{LG2} represents the refractive power of the second lens group.

As a result, the stop obtains an optimal size to effectively reduce or avoid the imaging aberrations and to adapt the diffraction-related unsharpnesses to the resolution of the sensor.

According to an aspect of the disclosure, the at least one lens group is made of a refractive, a diffractive, and/or a reflective material.

This measure facilitates effective light steering, for example by way of refraction, diffraction and/or interference. As an alternative or in addition thereto, the at least one lens group may include a glass, which is particularly suitable for a pinhole optical device.

According to yet another aspect of the disclosure, the optical imaging device has a telecentric embodiment on the image side.

This advantageously minimizes the influence of camera chip displacements in relation to the image plane of the imaging optical device.

According to an aspect of the disclosure, at least one metrological optical imaging device according to one or more of the above-described aspects of the disclosure or a pinhole camera is used to image a movable object, located in an object space, onto an image space in order to determine a position of the object in the object space.

Advantageously, this can effectively avoid distortions in a simple manner in order to increase the accuracy of the determination of positions.

A metrological system according to an aspect of the disclosure for determining positions includes at least one optical imaging device according to one or more of the above-described aspects of the disclosure or a pinhole camera and an image sensor for capturing an image of the movable object produced by the optical imaging device. By way of example, the optical imaging device may include an object-side and an image-side lens group, wherein the image sensor is arranged in a region of an image-side focus of the at least one lens group, typically the image-side lens group.

Further advantages and features are gathered from the following description and the attached drawing.

It goes without saying that the aforementioned features and the features yet to be explained below can be used not only in the respectively specified combination but also in other combinations or on their own, without departing from the scope of the present disclosure.

### BRIEF DESCRIPTION OF THE DRAWINGS

The disclosure will now be described with reference to the drawings wherein:

FIG. 1 shows a schematic illustration of a metrological system for determining positions with an optical imaging device according to an exemplary embodiment;

FIG. 2 shows a schematic illustration of the principle of an optical imaging device;

FIG. 3A shows a schematic meridional section of a metrological optical arrangement known from the related art;

FIG. 3B shows a diagram for elucidating connecting lines of arbitrary object points to their image points in the surroundings of an entrance pupil;

FIG. 4 shows a schematic meridional section of a metrological optical imaging device according to a further exemplary embodiment;

FIG. 5 shows a schematic meridional section of a metrological optical imaging device according to a further exemplary embodiment;

FIG. 6 shows a schematic meridional section of a metrological optical imaging device according to a further exemplary embodiment;

FIG. 7 shows a schematic meridional section of a metrological optical imaging device according to a further exemplary embodiment;

FIG. 8 shows a schematic meridional section of a metrological optical imaging device according to a further exemplary embodiment;

FIG. 9A shows a schematic illustration of the relationships in a pinhole camera;

FIG. 9B shows a sectional view of the pinhole camera shown in FIG. 9A; and

FIG. 10 shows a schematic illustration of an arrangement made of three metrological optical imaging devices or pinhole cameras for imaging three markers according to a further exemplary embodiment.

### DESCRIPTION OF EXEMPLARY EMBODIMENTS

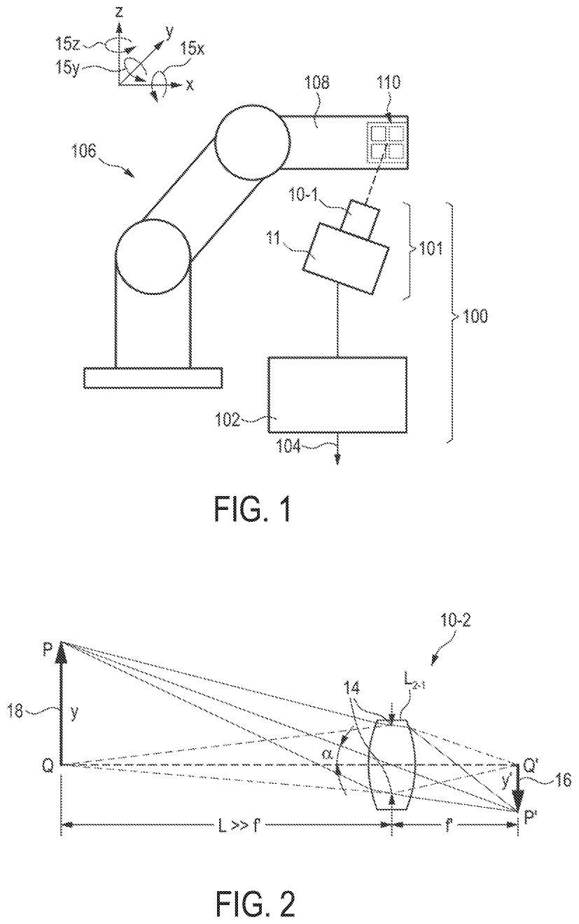

FIG. 1 shows a schematic illustration of a metrological system 100 for determining the position of a movable object in space, according to an exemplary embodiment. In the shown exemplary embodiment, the object is a robotic arm 108 of a measuring and/or processing machine 106, a marker 110 having been attached thereto in exemplary fashion. The robotic arm 108 is movable, for example movable in translational fashion and/or rotatably movable, with the marker 110 having a stationary arrangement with respect to the robotic arm 108. By capturing the position information items (i.e., the x-, y-, and z-coordinates and/or the orientation) of the marker 110, it is possible to determine the position of the movable robotic arm 108. A Cartesian coordinate system with the axes 15x, 15y, and 15z has been shown in FIG. 1 for elucidation purposes.

The marker 110 shown in exemplary fashion in FIG. 1 does not restrict the present disclosure. Moreover, a rough surface of the robotic arm 110 can serve the same purpose in place of a marker.

The system 100 includes an image capture unit 101 and an image evaluation unit 102. Typically, the image capture unit 101 is a camera, for example a video camera, which includes an optical imaging device 10-1 and an image sensor 11. Typically, the optical imaging device 10-1 is an objective lens and serves to image the marker 110 onto an image space located in the image sensor 11. The image of the marker 110 arising in the process is captured by the image sensor 11. The image sensor 11 can be configured as a commercially available image sensor.

Typically, the camera is embodied to capture images of the marker 110 continuously or regularly in a temporal sequence such that the changing positions of the object can be tracked at all times.

The image evaluation unit 102 of the system 100 is provided downstream of the image capture unit 101 and serves to evaluate the image of the marker 110, captured by the image sensor 11, for the purposes of ascertaining the current position of the object 108.

The result 104 of determining the position by the image evaluation unit 102 is output by the latter, for example to a display, not illustrated, or to an open-loop or closed-loop control for open-loop or closed-loop movement control of the object 108.

The system 100 may be embodied as a pure measuring system for tracking the movements of the object 108. As an alternative or in addition thereto, the system 100 can be used for open-loop or closed-loop movement control for the object 108.

While the system 100 has been shown with only a single camera and a single marker 110 in FIG. 1 for simplicity, it is understood that the system 100 may include a plurality of cameras and a plurality of markers 110. Here, the plurality of markers 110 can be attached to the object 108 at different positions. The cameras may be distributed in space and the number of cameras may be chosen so as to observe the respective markers 110 from different viewing angles.

In order to describe the pose of the robotic arm 108, the pose of its work point in Cartesian coordinates and the orientation or direction of its internal coordinate system are necessary. A plurality of optical imaging systems with a sensor positioned in space capture the image coordinates of the markers and make available direction vectors from their coordinate system to the markers of the image evaluation unit 102. By triangulation, this determines the description of the pose of the robotic arm 108 in terms of position and direction.

FIG. 2 shows a schematic illustration of the principle of an ideal optical imaging device 10-2. The optical imaging device 10-2 is embodied to image an object (illustrated as an arrow in exemplary fashion in FIG. 2) from an object space 18 onto an image (illustrated as an arrow in exemplary fashion in FIG. 2) on an image sensor 16. To this end, the optical imaging device 10-2 includes a convex lens L₂₋₁ and a pinhole 14. Beams emanating from a first object point P of the object y are guided through the convex lens L₂₋₁ in the direction of the pinhole 14 and coincide in a first image point P′. Analogously, beams emanating from a second object point Q of the object y, too, are guided to a second image point Q′. In this way, an image y′ of the object y arises in the image space of the image sensor 16. Here, the model assumption is made that the connecting line P-P′ extends for arbitrary sizes y and L. The connecting line P-P′ includes an angle a with the connecting line Q-Q′.

This means that the ideal optical imaging device is distortion free, as in the case of a pinhole camera or camera obscura, and thus realizes “pinhole optics.” Compared to a camera obscura, the ideal camera has a light-converging effect and is suitable for fast measuring objects.

The principle of imaging from a measuring volume is not considered in FIG. 2. The system schematically illustrated in FIG. 2 is only distortion-free for one plane, in which the object is imaged on the sensor plane in focus.

In FIG. 2, the optical imaging device is symbolically represented by only a single lens. This does not restrict the present disclosure. In general, the optical imaging device may include a plurality of lenses, prisms and/or mirrors. Further, the optical imaging device may generally include a glass, a refractive, a diffractive, and/or a reflective material.

Advantageously, the determination of the positions of the objects, in particular tools and/or machines, in the image space can be simplified from a computational point of view and consequently can be significantly improved on account of avoiding, or at least however reducing, distortion aberrations. Consequently, position data in the object space can be deduced with increased accuracy from the position data in the image space.

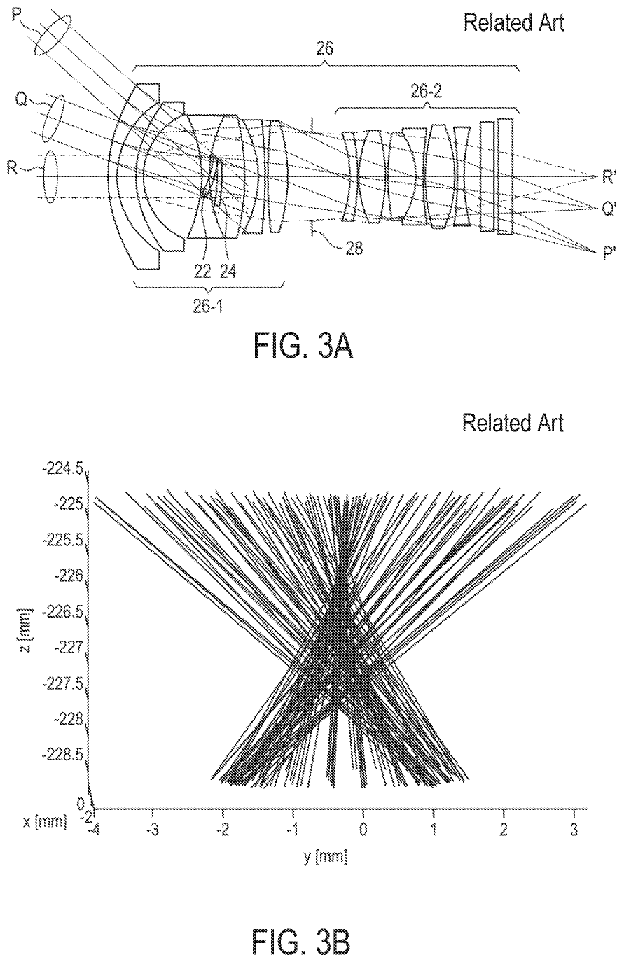

For comparison purposes, FIG. 3A shows an optical arrangement known from the related art, said arrangement includes a plurality of lenses 26 and a stop 28. Beams P, Q, and R emanate at different field angles from an object (not shown), said beams being guided through a first lens group 26-1 to the stop 28 and subsequently being focused on the image points P′, R′, and Q′ by a second lens group 26-2. Two entrance pupils 22 and 24, each for the beams P and Q, are plotted in FIG. 3A, said entrance pupils having different poses.

FIG. 3B shows a diagram for elucidating the connecting lines of arbitrary object points to their image points in the surroundings of the entrance pupil, which arise during the imaging by means of the optical arrangement of FIG. 3A. The lines have no common point of intersection.

For the purposes of calculating object coordinates from image coordinates by triangulation, the following condition (1) needs to be satisfied:

tan(α)·G=y′ (1)

Condition (1) applies to objects located at infinity and a distortion-free optical device or a pinhole camera. In this case, the constant G adopts the value f′ of the objective lens focal length.

The relationship for an ideal optical device and an object pose at infinity is generalized for a finite object pose. For objects at a finite distance, condition (2)

tan(α)=y/L (2)

is assumed, where L denotes the distance between the object and the pinhole and y denotes the axial distance of the object. For the purposes of describing the fundamental optical relationships, an optical group is replaced in the model by two principal planes. The points of intersection thereof with the optical axis are the principal points. If the distance L coincides with the distance a from the object to the front principal point of the optical device and if a′ denotes the distance from the back principal point to the sensor or image plane, the following condition (3) applies for paraxial imaging:

y′/a′=y/a, (3)

where rewriting condition (3) taking account of y/a=tan(α) leads to a′ taking over the task of G.

y/a·a′=y′ (4)

Equation (4) describes the relationship between object and image back focal lengths and heights of an imaging optical system in the structure of Equation (1). For an ideal optical system, a constant G is desired, for which Equation (1) is satisfied for all possible values y and L. Equation (4) has the same structure as Equation (1) with defined variables y, y′, a, and a′. In this structure,

G is in front of the equality sign in Equation (1). In Equation (4), a′ is found at this position.

On account of the fundamental relationship (5) of the paraxial imaging:

1/a′−1/a=1/f′ (5)

no common a′ arises for arbitrary values of a, which applies for every a. Objects with a common field angle a but different distances are already imaged with different degrees of sharpness in the case of paraxial imaging. For details of the markers, the localization of edges within an image is possible, even in the case of unsharp imaging. A light cone propagates at an angle to the capture plane for the pinhole camera. An elliptical form which, under certain circumstances, has a different edge gradient, arises in the sectional plane. This is disadvantageous for localizing the image of an edge. A uniform edge gradient arises in the case where the principal axes of the ellipse have the same size (i.e., describe a circle). To this end, it is desirable for the light cone to be perpendicular to the capture plane.

Such a geometric uniformity of the unsharpnesses can be obtained by an objective lens that is telecentric on the image side. Moreover, the light emanating from the object at the angle a is incident obliquely at the angle α′ on the pinhole with a diameter D which restricts the luminous flux. The meridional effective aperture consequently is cos(α′)·D, while the sagittal aperture perpendicular thereto is D. The angle α′ at the location of the pinhole can be reduced if a transformation system is arranged between the object and the pinhole, said transformation system realizing the function (6):

tan(α′)=α·tan(α) where ||<1. (6)

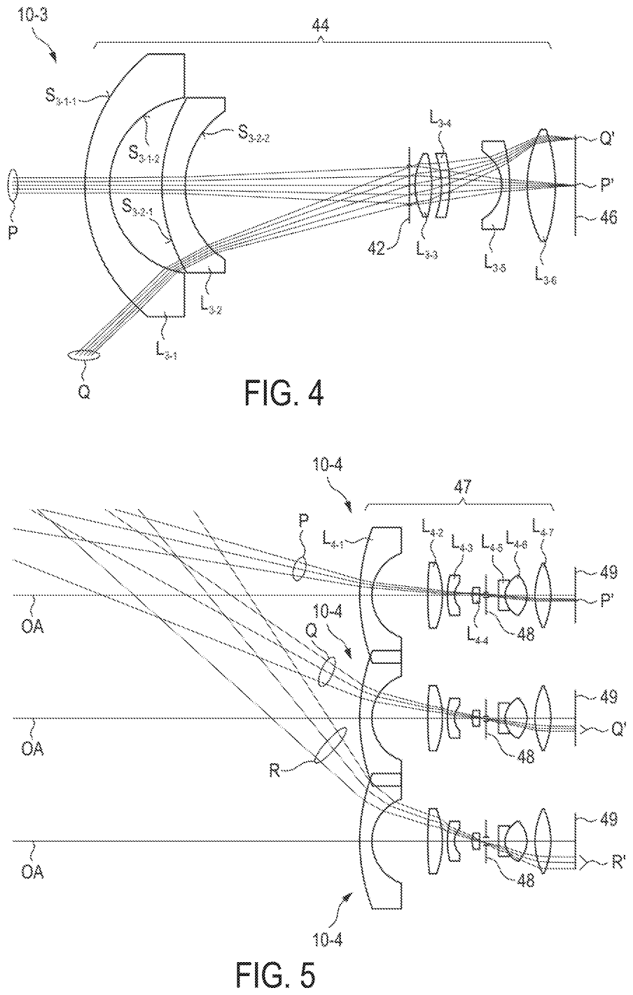

Afocal systems with a telescope magnification Γ with |Γ|<1 have such a property. Both systems with a Kepler-type characteristic and systems with a Galilean-type characteristic are conceivable here, with the latter being advantageous on account of its compact structure. A group having negative refractive power has the same advantageous property. An exemplary embodiment is shown in FIG. 4.

A constant pose of the entrance pupil of the transformation system for different object distances and/or different object heights is further advantageous. Such a transformation system is corrected in respect of aperture aberrations of the pupil imaging. All rays directed to the center of the entrance pupil strike the aperture stop centrally.

Further, the optical imaging device typically has a telecentric embodiment on the image side to minimize the influence of camera chip displacements in relation to the image plane of the imaging optical device and in order to avoid asymmetry in the edge blurring of unsharp edges.

FIGS. 4 to 8 show optical imaging devices according to further exemplary embodiments, in which the triangulation of markers within a measuring volume is performable with simplified calibration and less provision outlay. The exemplary embodiments are telecentric on the image side.

FIG. 4 shows an optical imaging device 10-3 according to an exemplary embodiment. The optical imaging device 10-3 includes a lens arrangement 44, which includes a plurality of lenses L₃₋₁, L₃₋₂, L₃₋₃, L₃₋₄, L₃₋₅, and L₃₋₆. Further, the optical imaging device 10-3 includes a pinhole 42, which is arranged between the second lens L₃₋₂ and the third lens L₃₋₃. Two exemplary beams P, Q enter the optical imaging device 10-3 at different field angles and are guided through the lens arrangement 44 and the pinhole 42 and are finally focused on two image points P′ and Q′ on the image plane 46. Here, the lens arrangement 44 and the pinhole 42 are designed in such a way that the pose of the entrance pupil is the same for the two beams P and Q.

The optical imaging device is a Petzval objective lens. The imaging of the entrance pupil on the stop is corrected. To this end, the first lens L₃₋₁ has a front lens face S₃₋₁₋₁ and a back lens face S₃₋₁₋₂. The front lens face S₃₋₁₋₁ has a concentric embodiment in respect of the main ray, with the back lens face S₃₋₁₋₂ having an aplanatic embodiment in respect of the main ray. Analogously, the second lens L₃₋₂ has a front lens face S₃₋₂₋₁ and a back lens face S₃₋₂₋₂. The front lens face S₃₋₂₋₁ has a concentric embodiment in respect of the main ray, with the back lens face S₃₋₂₋₂ having an aplanatic embodiment in respect of the main ray. The respective main ray passes through the center of the pinhole aperture in each of the various beams (for example P, Q) of a field of view over a field angle of 0 to 90 degrees. This allows the aberrations in the main ray to be at least greatly minimized for any arbitrary field angle.

Advantageously, compared to conventional optical devices, the navigation of a movable object on the basis of triangulation with the aid of the pinhole camera characteristic of the employed optical devices and digitally corrected distortion can be carried out more accurately and reliably with the optical imaging devices 10-1 to 10-3.

FIG. 5 shows an optical imaging device 10-4, which includes a lens arrangement 47 and a pinhole 48. The lens arrangement 47 includes a plurality of lenses L₄₋₁, L₄₋₂, L₄₋₃, L₄₋₄, L₄₋₅, L₄₋₆, and L₄₋₇, with the pinhole 48 being arranged between the fourth lens L₄₋₄ and the fifth lens L₄₋₅. The lenses L₄₋₁, L₄₋₂, L₄₋₃, and L₄₋₄ upstream of the stop 48 form a first lens group LG1, with the lenses L₄₋₅, L₄₋₆, and L₄₋₇ downstream of the stop 48 forming a second lens group LG2.

Three exemplary beams P, Q, and R enter the optical imaging device 10-4 and are guided through the lens arrangement 47 and the pinhole 48 and are finally focused on the image points P′, Q′, and R′ on the image plane 49. It is evident in the respective beam that the individual incidence light rays with different field angles focus at the location of the pinhole 48 before they are focused on the respective image points by the second lens group. The beams P, Q, and R intersect the optical axis at a common point (not illustrated). Consequently, a common entrance pupil pose is defined for beams with different field angles. The focal line f′ is 8 mm in the exemplary optical imaging device 10-4. The telescope magnification factor F_{LG1} of the first lens group is 0.4. The focal length f_{LG1} of the first lens group is 18.71 mm, with the focal length f_{LG2} of the second lens group being 18.57 mm. The diameter of the aperture of the pinhole 48 is 1.12 mm. The minimum and maximum distance aₘᵢₙ, aₘₐₓ between the object and the front lens vertex of the optical imaging device 10-4 are 305 mm and 1720 mm, respectively.

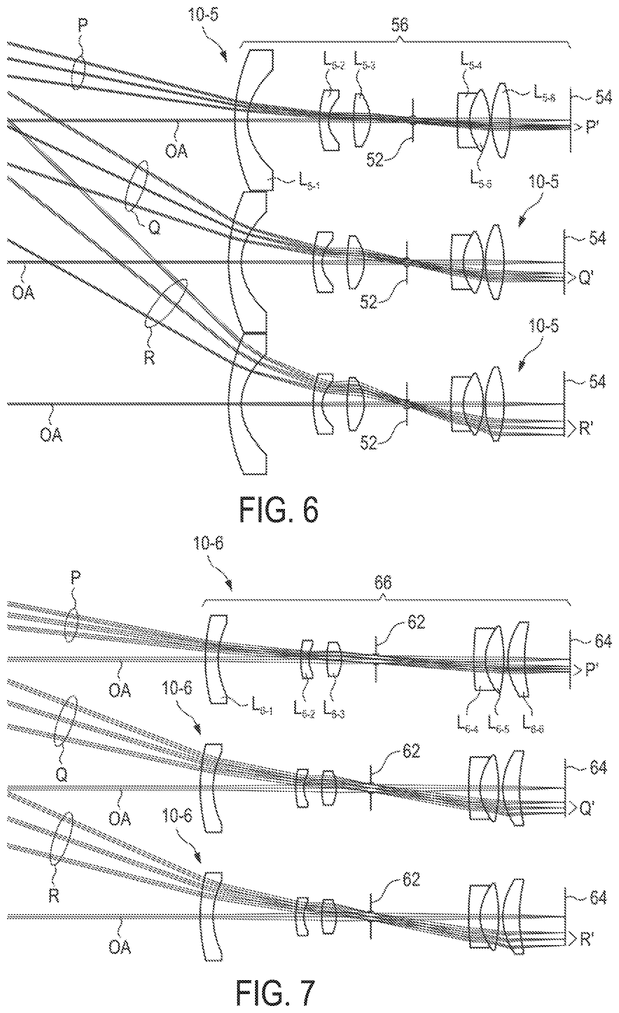

FIG. 6 shows a further optical imaging device 10-5, which includes a lens arrangement 56 and a pinhole 52. The lens arrangement 56 includes a plurality of lenses L₅₋₁, L₅₋₂, L₅₋₃, L₅₋₄, L₅₋₅, and L₅₋₆, with the pinhole 52 being arranged between the third lens L₅₋₃ and the fourth lens L₅₋₄. The lenses L₅₋₁, L₅₋₂, and L₅₋₃ upstream of the stop 52 form a first lens group LG1, with the lenses L₅₋₄, L₅₋₅, and L₅₋₆ downstream of the stop 52 forming a second lens group LG2.

Three exemplary beams P, Q, R enter the optical imaging device 10-5 and are guided through the lens arrangement 56 and the pinhole 52 and are finally focused on the image points P′, Q′, and R′ on the image plane 54. It is evident in the respective beam that the individual incidence light rays with different field angles focus at the location of the pinhole 52 before they are focused on the respective image points by the second lens group. The beams P, Q, and R intersect the optical axis at a common point (not illustrated). Consequently, a common entrance pupil pose is defined for beams with different field angles.

The focal line f′ is 12 mm in the exemplary optical imaging device 10-5. The telescope magnification factor ΓLG1 of the first lens group is 0.4. The focal length fLG1 of the first lens group is 59.7 mm, with the focal length fLG2 of the second lens group being 27.847 mm. The diameter of the aperture of the pinhole 52 is 1.66 mm. The minimum and maximum distance aₘᵢₙ, aₘₐₓ between the object and the front lens vertex of the optical imaging device 10-5 are 493 mm and 1906 mm, respectively.

FIG. 7 shows a further optical imaging device 10-6, which includes a lens arrangement 66 and a pinhole 62. The lens arrangement 66 includes a plurality of lenses L₆₋₁, L₆₋₂, L₆₋₃, L₆₋₄, L₆₋₅, and L₆₋₆, with the pinhole 62 being arranged between the third lens L₆₋₃ and the fourth lens L₆₋₄. The lenses L₆₋₁, L₆₋₂, and L₆₋₃ upstream of the stop 62 form a first lens group LG1, with the lenses L₆₋₄, L₆₋₅, and L₆₋₆ downstream of the stop 62 forming a second lens group LG2.

Three exemplary beams P, Q, and R enter the optical imaging device 10-6 and are guided through the lens arrangement 66 and the pinhole 62 and are finally focused on the image points P′, Q′, and R′ on the image plane 64. It is evident in the respective beam that the individual incidence light rays with different field angles focus at the location of the pinhole 62 before they are focused on the respective image points by the second lens group. The beams P, Q, and R intersect the optical axis at a common point (not illustrated). Consequently, a common entrance pupil pose is defined for beams with different field angles.

The focal line f′ is 25 mm in the exemplary optical imaging device 10-6. The telescope magnification factor Γ_{LG1} of the first lens group is 0.6. The focal length f_{LG1} of the first lens group is 28.01 mm, with the focal length f_{LG2} of the second lens group being 44.357 mm. The diameter of the aperture of the pinhole 62 is 2.68 mm. The minimum and maximum distance aₘᵢₙ, aₘₐₓ between the object and the front lens vertex of the optical imaging device 10-6 are 1350 mm and 2765 mm, respectively.

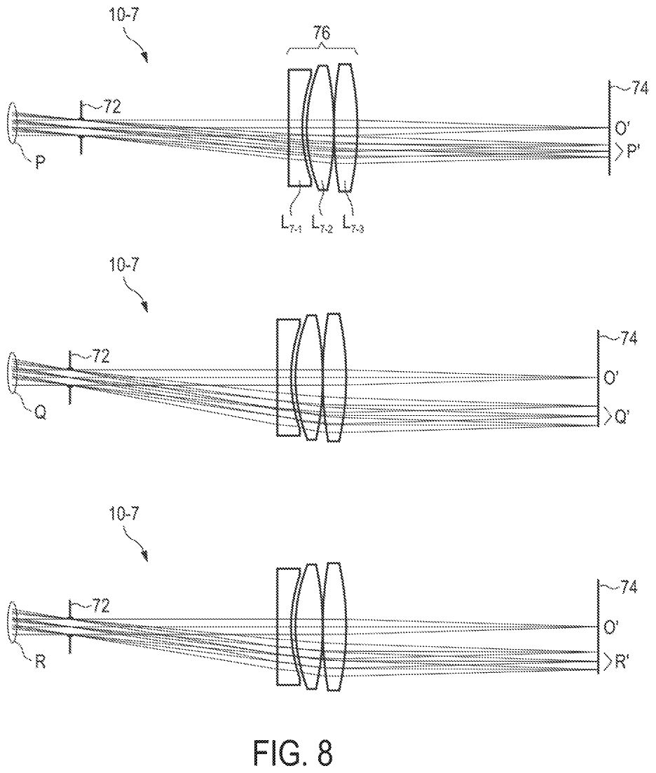

Finally, FIG. 8 shows a further optical imaging device 10-7, which includes a lens arrangement 76 and a pinhole 72. The lens arrangement 76 includes a plurality of lenses L₇₋₁, L₇₋₂, and L₇₋₃, with the pinhole 72 being arranged upstream of the first lens L₇₋₁.

Three exemplary beams P, Q, and R enter the optical imaging device 10-7 and are guided through the lens arrangement 76 and the pinhole 72 and are finally focused on the image points P′, Q′, and R′ on the image plane 74. It is evident in the respective beam that the individual incidence light rays with different field angles focus at the location of the pinhole 72 before they are focused on the respective image points by the lens arrangement 76. Consequently, a common entrance pupil pose is defined for beams with different field angles.

The focal length f′ is 50 mm in the exemplary optical imaging device 10-7. The diameter of the aperture of the pinhole 72 is 3 mm. The minimum and maximum distance aₘᵢₙ, aₘₐₓ between the object and the stop of the optical imaging device 10-7 are 2925 mm and 4340 mm, respectively.

The sensor can be arranged in, or in the immediate vicinity of, the back focus of the second lens group LG2 in the optical imaging devices 10-4, 10-5, 10-6. The sensor can be arranged in, or in the immediate vicinity of, the back focus of the lens arrangement 76 in the optical imaging device 10-7.

For the purposes of calibrating the systems according to any one of the exemplary embodiments, the description of the distortion and the parameters G and L from conditions (1) and (2) above are matched to an exemplary measurement scenario.

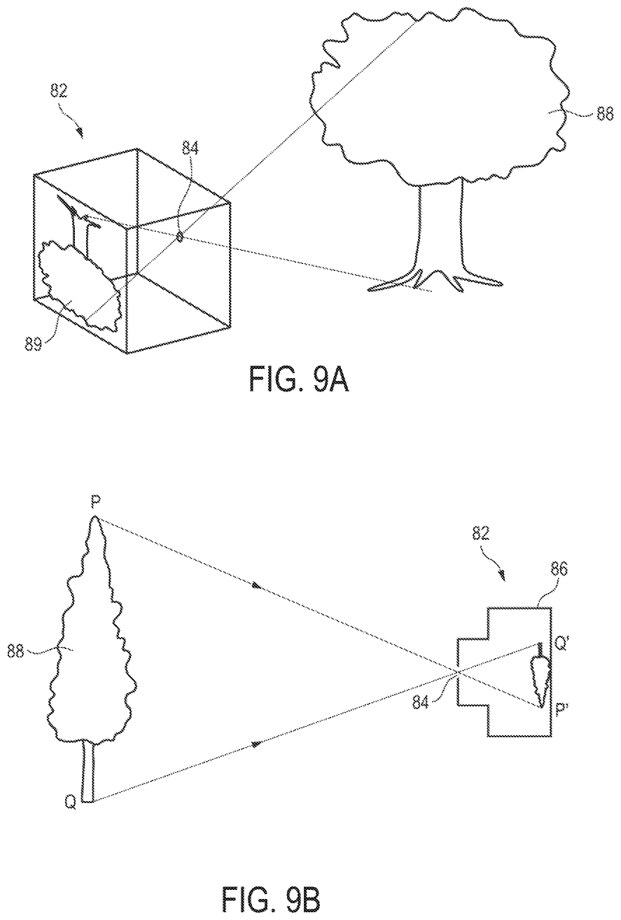

FIG. 9A schematically shows the integration of an ideal optical imaging device 10-1, as illustrated in FIG. 2, with a sensor to form a pinhole camera 82 for the ideal imaging of an object 88 represented as a tree in an exemplary manner. The pinhole camera 82 has a stop 84, through which beams emanating from the object 88 pass and are finally focused on image points of the image 89. FIG. 9B shows a sectional view of the pinhole camera 82 shown in FIG. 9A. It is evident there that beams emanating from two exemplary object points P and Q are imaged on two image points P′ and Q′ by the pinhole camera 82.

The use of the pinhole camera 82 according to an exemplary embodiment of the disclosure for capturing a position of a movable object allows positions (i.e., spatial coordinates and orientations or directions) of the objects to be deduced uniquely and quickly from image coordinates. Optical devices corresponding to the exemplary embodiments shown in FIGS. 5 to 8 include a sensor and a digital distortion correction integrated in the image evaluation unit 102 (see FIG. 1), meet the requirements of a pinhole camera and can be used as such.

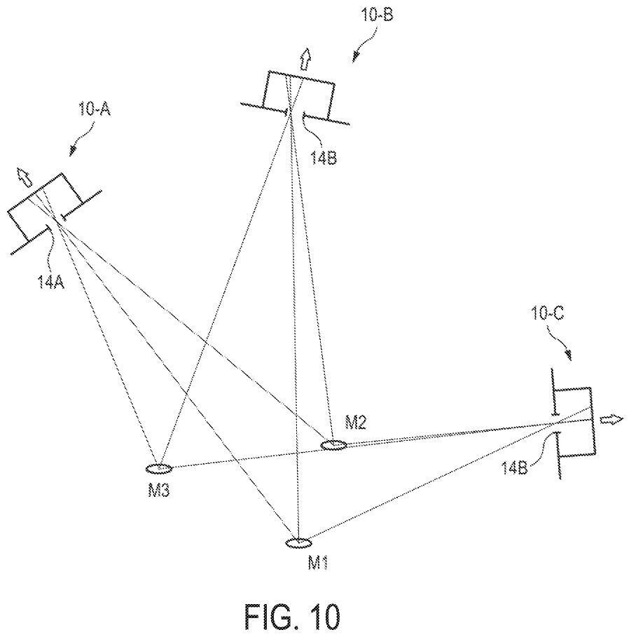

FIG. 10 schematically shows an arrangement made of three optical imaging devices 10-A, 10-B, and 10-C for imaging three markers M1, M2, and M3. Beams emanating from the respective markers M1, M2, and M3, which are typically Lambert emitters, enter the respective optical imaging device 10-A, 10-B, and 10-C. As shown in FIG. 10 in exemplary fashion, the optical imaging devices 10-A, 10-B, and 10-C each have a front stop 14A, 14B, and 14C. Alternatively, at least one optical imaging device may include a central stop.

Three pinhole cameras may also be used in place of the optical imaging devices. A combination in which one or two of the optical imaging devices is/are replaced by one or two pinhole cameras is likewise conceivable.

The positions of the markers M1, M2, and M3 can initially be captured in the image space on the basis of triangulation by the arrangement shown in FIG. 10. The ideal imaging of the image coordinates in object directions and the mutually known pose relationship between the optical imaging devices 10-A, 10-B, and 10-C or the pinhole cameras allows the positions of the markers M1, M2, and M3 in the object space to be deduced by triangulation. Distance-dependent distortion aberrations can be effectively reduced thanks to the constant pose of the entrance pupil of the respective optical imaging devices 10-A, 10-B, and 10-C or the respective pinhole cameras, and so positions can be determined with increased accuracy.

It is understood that the foregoing description is that of the exemplary embodiments of the disclosure and that various changes and modifications may be made thereto without departing from the spirit and scope of the disclosure as defined in the appended claims.

What is claimed is:

1. A metrological optical imaging device for imaging a movable object located in an object space onto an image space to determine a position of the movable object in the object space, the metrological optical imaging device comprising:
at least one lens group including an image-side lens group;
a stop defining an entrance pupil for beams emanating from the movable object, the entrance pupil having a same pose for at least two of the beams having different field angles;
the at least one lens group and the stop being arranged in an object-side focus of the image-side lens group; and
the metrological optical imaging device being arranged between the object space and the image space.

2. The metrological optical imaging device according to claim 1, wherein:
the at least one lens group includes an object-side lens group, and
the stop is arranged between the object-side lens group and the image-side lens group of the at least one lens group.

3. The metrological optical imaging device according to claim 1, wherein the image-side lens group has a positive refractive power.

4. The metrological optical imaging device according to claim 1, wherein the image-side lens group define a focal length in a range from 15 mm to 200 mm.

5. The metrological optical imaging device according to claim 2, wherein the object-side lens group and the image-side lens group together define a focal length in a range from 5 mm to 200 mm.

6. The metrological optical imaging device according to claim 2, wherein:
the image-side lens group defines a first focal length,
the object-side lens group and the image-side lens group together define a second focal length, and
the first focal length is larger than or equal to the second focal length.

7. The metrological optical imaging device according to claim 6, wherein a ratio between the second focal length and the first focal length is in a range from 0.3 to 1.

8. The metrological optical imaging device according to claim 1, wherein the stop has a diameter that satisfies:
0.03·f_{LG2}<D<0.10·f_{LG2}
where D represents the diameter of the stop and f_{LG2} represents a refractive power of the image-side lens group.

9. The metrological optical imaging device according to claim 1, wherein:
the at least one lens group includes a first lens and a second lens,
the first and/or the second lens has an object-side lens face and an image-side lens face,
the object-side lens face has a concentric shape with respect to a principal beam path and the image-side lens face has an aplanatic shape with respect to the principal beam path.

10. The metrological optical imaging device according to claim 1, wherein the at least one lens group includes lenses made of a refractive, a diffractive, and/or a reflective material.

11. A method for determining a position of a movable object located in an object space, the method comprising:
providing a metrological optical imaging device and/or a pinhole camera, the metrological optical imaging device including at least one lens group, the at least one lens group including an image-side lens group and a stop, the stop defining an entrance pupil for beams emanating from the movable object, the entrance pupil having a same pose for at least two of the beams having different field angles;
arranging the at least one lens group and the stop in an object-side focus of the image-side lens group;
arranging the metrological optical imaging device and/or the pinhole camera between the object space and an image space; and
imaging the movable object with the metrological optical imaging device onto the image space.

12. A metrological system for determining a position of a movable object in an object space, the metrological system comprising:
at least one metrological optical imaging device and/or at least one pinhole camera, the at least one metrological optical imaging device including at least one lens group, the at least one lens group including an image-side lens group and a stop, the stop defining an entrance pupil for beams emanating from the movable object, the entrance pupil having a same pose for at least two of the beams having different field angles, the at least one lens group and the stop being arranged in an object-side focus of the image-side lens group, and the at least one metrological optical imaging device being arranged between the object space and an image space; and
an image sensor configured to capture an image of the movable object generated by the at least one metrological optical imaging device or by the at least one pinhole camera.
